(19) United States
(12) Patent Application Publication
(10) Pub. No.: US 2024/0257198 A1
(43) Pub. Date: Aug. 1, 2024

(54) SERVER AND METHOD FOR PROVIDING E-COMMERCE PLATFORM SERVICE THAT INVITES USERS TO A LAYER STRUCTURE CONSISTING OF A PLURALITY OF SELLERS

(71) Applicant: CONIALAB CO., LTD., Seoul (KR)

(72) Inventor: HYUN JUNG NA, Gyeonggi-do (KR)

(21) Appl. No.: 18/424,976

(22) Filed: Jan. 29, 2024

(30) Foreign Application Priority Data
Jan. 27, 2023 (KR) 10-2023-0010645

(51) Int. Cl. G06Q 30/0601

(52) U.S. Cl. CPC G06Q 30/0613; G06Q 30/0603; G06Q 30/0631

(57) ABSTRACT

An e-commerce platform server according to an embodiment includes a communication device, a memory that stores one or more instructions, and a processor that executes the one or more instructions stored in the memory, in which the processor, by executing the one or more instructions, registers at least one of users of the e-commerce platform service in a seller database (DB) as a seller in a hierarchy consisting of a top seller and at least one sub-seller subordinate to the top seller and generates an online shop of a user registered as the seller, the online shop including at least one of sales products registered in a sales products DB by the top seller in the hierarchy, and the sales product may be at least one of supply products registered in a supply products DB.

### CROSS REFERENCE TO RELATED APPLICATION AND CLAIM OF PRIORITY

This application claims the benefit under 35 USC § 119 of Korean Patent Application No. 10-2023-0010645, filed on Jan. 27, 2023, in the Korean Intellectual Property Office, the entire disclosure of which is incorporated herein by reference for all purposes.

### BACKGROUND

### 1. Field

Embodiments of the present disclosure relate to a platform service technology for providing an e-commerce environment.

### 2. Description of Related Art

With the development of information and communication technology, online commerce, that is, e-commerce, which involves selling a product by building an online market, has developed. The initial form of online commerce was in the form in which a seller opened an online shopping mall (hereinafter referred to as shopping mall) directly, registered the product, and a visitor who accessed the shopping mall purchased the product, but with the advent of intermediary shopping malls that connect a seller and a purchaser emerged and grew into a large shopping malls (e.g., Auction, 11th Street, G Market, etc.) by providing convenient sales and purchasing services, which leads to explosive growth in an e-commerce market. Since then, this explosive growth has continued with the emergence of social commerce using social networks (e.g., Tmon, Wemakeprice) and various forms of e-commerce (e.g., Coupang) that provide innovative offline distribution and logistics services. These large-scale e-commerce platforms (e.g., large intermediary platforms, social commerce, etc.) are bringing large profits to a user, especially the seller.

Recently, a new type of e-commerce market is being actively formed using communication channels with fans of highly influential individuals with great influence on social network services (SNS) (e.g., Facebook, Instagram) and individual media services (e.g., influencer, celebrity, etc.), or through strong personal networks in communities where people with similar personal interests gather.

### SUMMARY

However, even if products are sold using the large-scale e-commerce platform described above, the seller should bear the initial costs for marketing (e.g., creation of product description pages, advertisement, etc.) and product distribution. And since the main source of income for these large-scale platforms is fees received from users, high fees may be charged to the users, especially the seller, depending on the size of the platform. In addition, competition for the lowest price with several sellers who have opened stores within the platform may lower a seller's margin rate, which may lead to a decrease in product quality and cause damage not only to purchasers and but also to platform services. Even if platform operators and a small number of sellers make a lot of profit in this process, this concentrated profit structure may stagnate or degrade the development of a platform ecosystem. In addition, the large-scale e-commerce platforms that focus on this relay of product sales may have limitations that make it difficult to make key members (e.g., influencer, community, etc.) of a newly formed e-commerce market through SNS, communities, etc. as new users on the e-commerce platform.

In addition, when a large number of sellers are made to participate in the e-commerce platform, it may be difficult for a manager to individually manage the new registration and sales state of the large number of sellers. And, if only a small number of sellers are allowed to increase the reliability of the market, the flexibility and diversity of the market are reduced and it is difficult to expand the scope of the service and accordingly, it may be difficult to satisfy the diverse needs of customers. In addition, if new sellers are indiscriminately accepted, there is no difference from the existing large e-commerce platform, which may reduce competitiveness.

Accordingly, various embodiments of the present disclosure are intended to provide an e-commerce platform service in which a plurality of sellers systematically sell products and at the same time, users of the platform service, such as purchasers of the products, can participate as new sellers.

A platform server for providing an e-commerce platform service according to an embodiment of the present disclosure includes a communication device, a memory that stores one or more instructions, and a processor that executes the one or more instructions stored in the memory, and the processor, by executing the one or more instructions, registers at least one of users of the e-commerce platform service in a seller DB as a seller in a hierarchy consisting of a top seller and at least one sub-seller subordinate to the top seller and generates an online shop of a user registered as the seller, the online shop including at least one of sales products registered in a sales products DB by the top seller in the hierarchy, and the sales product is at least one of supply products registered in a supply products DB.

And, in the platform server according to the embodiment, the processor, by executing the one or more instructions, may provide invitation information for registering the user as a seller, receive application information for being registered as the seller from a terminal of the user through the invitation information, and register the user as the seller in the hierarchy in the seller DB based on the received application information, when registering the user as the seller in the hierarchy.

In addition, in the platform server according to the embodiment, the processor, by executing the one or more instructions, may provide the invitation information in response to a request from at least one terminal among a plurality of sellers included in the hierarchy when providing the invitation information.

In addition, in the platform server according to the embodiment, the processor, by executing the one or more instructions, may transmit the invitation information to a terminal of a designated user as the seller if a request for registering the designated user is received from a terminal of the seller when providing the invitation information in response to the request, and receive application information from the terminal of the designated user through the invitation information when receiving the application information.

In addition, in the platform server according to the embodiment, the processor, by executing the one or more instructions, may provide consulting information for recommending the designated user to at least one terminal among the plurality of sellers based on usage history information of the e-commerce platform service, and receive a request for invitation information for registering the designated user as the seller from the terminal of the seller who provided the consulting information.

In addition, in the embodiment of the present disclosure, the usage history information may include at least one of creation history information of content for promoting sales products on the e-commerce platform service and purchase history information.

In addition, in the platform server according to the embodiment, the processor, by executing the one or more instructions, may transmit the invitation information to the terminal of the seller that requested the invitation information in response to a request for registering any user as the seller from the seller terminal when providing the invitation information, and receive the application information from the terminal of the user who received the invitation information from the seller when receiving the application information.

In addition, in the platform server according to the embodiment, the processor, by executing the one or more instructions, may register the user to be registered through the invitation information in the seller DB as a sub-seller subordinate to the seller who requested the invitation information.

In addition, in the platform server according to the embodiment, the processor, by executing the one or more instructions, may register, based on usage history information on the e-commerce platform service of the user, the user as a sub-seller directly subordinate to the seller who requested the invitation information, or as a sub-seller indirectly subordinate to the seller who requested the invitation information through another sub-seller who is subordinate to the seller who requested the invitation information when registering the user as the sub-seller of the seller who requested the invitation information.

In addition, in the platform server according to the embodiment, the processor, by executing the one or more instructions, may determine a user to be registered as a sub-seller subordinate to a designated top seller in the hierarchy based on usage history information on the e-commerce platform service and transmits the invitation information to a terminal of the determined user, when providing the invitation information, receive the application information from the terminal of the determined user through the invitation information when receiving the application information, and register the user as the sub-seller subordinate to the designated top seller when registering the user as the seller in the hierarchy.

In addition, in the platform server according to the embodiment, the processor, by executing the one or more instructions, may provide consulting information including information on the designated top seller and the invitation information based on the usage history information of the e-commerce platform service.

In addition, in the platform server according to the embodiment, the processor, by executing the one or more instructions, may register at least one of a content creator who provides content for promoting the sales product to the e-commerce platform service and a purchaser who purchases the sales product through an online shop of the e-commerce platform service as the seller in the hierarchy in the seller DB, when registering the user as the seller in the hierarchy.

In addition, in the platform server according to the embodiment, the processor, by executing the one or more instructions, may register an operator of an offline shop, who is a user of an online platform service, as the seller in the hierarchy in the seller DB, when registering the user as the seller in the hierarchy.

In addition, in the platform server according to the embodiment, the processor, by executing the one or more instructions, may register the operator of the offline shop as a top seller of the hierarchy in the seller DB when registering the operator of the offline shop as the seller, and register a product sold in the offline shop in the sales products DB and generate the online shop of the operator including the product of the offline shop registered as the sales products, when creating an online shop of the user registered as the seller.

In addition, in the platform server according to the embodiment, the processor, by executing the one or more instructions, may generate a catalog containing the products registered in the sales products DB, and the generated catalog may include link information that leads to each product page where sales products in the online shop of the operator may be purchased.

In addition, in the platform server according to the embodiment, the processor, by executing the one or more instructions, may register a visitor of the offline shop as a member of the online shop of the operator when the visitor accesses the e-commerce platform server through invitation information of the operator.

In addition, in the platform server according to the embodiment, the processor, by executing the one or more instructions, may provide recommendation information about at least one of a plurality of online shops on the e-commerce platform based on purchase history information at the offline shop when a visitor of the offline shop accesses the e-commerce platform server through the invitation information of the operator.

In addition, in the platform server according to the embodiment, the processor, by executing the one or more instructions, may register a visitor of the offline shop in the seller DB as a sub-seller subordinate to the operator registered as the seller when the visitor accesses the e-commerce platform server through the invitation information of the operator.

A method for providing an e-commerce platform service according to another embodiment of the present disclosure includes registering at least one of users of the e-commerce platform service in a seller DB as a seller in a hierarchy consisting of a top seller and at least one sub-seller subordinate to the top seller, and generating an online shop of a user registered as the seller, the online shop including at least one of sales products registered in a sales products DB by the top seller in the hierarchy, and the sales product being at least one of supply products registered in a supply products DB.

A computer program stored in a computer readable storage medium and configured to be executed by one or more processors according to still another embodiment of the present disclosure, the computer program for providing an e-commerce platform service including an instruction for registering at least one of users of the e-commerce platform service in a seller DB as a seller in a hierarchy consisting of a top seller and at least one sub-seller subordinate to the top seller, and an instruction for generating an online shop of a user registered as the seller, the online shop including at least one of sales products registered in a sales products DB by the top seller in the hierarchy, the sales product being at least one of supply products registered in a supply products DB.

### BRIEF DESCRIPTION OF THE DRAWINGS

FIG. 1 is a diagram illustrating an e-commerce environment according to various embodiments.

FIG. 2 is a diagram illustrating a configuration of an e-commerce platform server according to an embodiment.

FIG. 3 is a flowchart illustrating a process in which a content creator and a purchaser are registered as new sellers in an e-commerce platform service according to an embodiment.

FIG. 4 is a diagram illustrating registering an operator of an offline shop as a new seller in the e-commerce platform service according to an embodiment.

FIG. 5 is a diagram illustrating that a user who is registered as a new seller in the e-commerce platform service is registered in a hierarchy of sellers according to an embodiment.

FIG. 6 is a diagram illustrating a UI of an existing seller for inviting a new seller in the e-commerce platform service according to an embodiment.

FIG. 7 is a diagram illustrating an UI of the existing seller for registering a new seller in the e-commerce platform service according to an embodiment.

FIG. 8 is a diagram illustrating a method for providing the e-commerce platform service according to an embodiment.

### DETAILED DESCRIPTION

Hereinafter, various embodiments of the present disclosure are described with reference to the attached drawings. However, this is not intended to limit the present disclosure to specific embodiments, and should be understood to include various modifications, equivalents, and/or alternatives to the embodiments of the present disclosure.

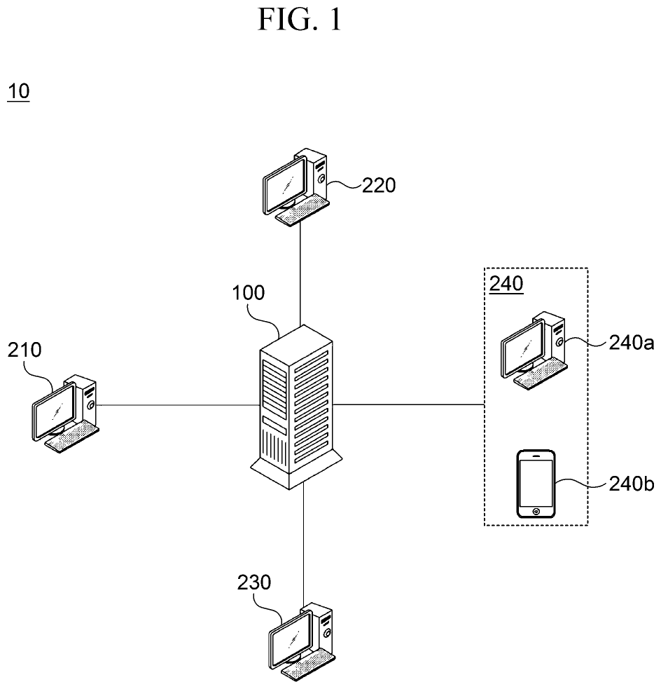

FIG. 1 is a diagram illustrating an e-commerce environment according to various embodiments.

Referring to FIG. 1, the e-commerce environment 10 may include a platform server 100, a supplier terminal 210, a seller terminal 220, a content creator terminal 230, and a purchaser terminal 240. The platform server 100 may be connected to the supplier terminal 210, the seller terminal 220, the content creator terminal 230, and the purchaser terminal 240 through a communication network.

The platform server 100 can provide an e-commerce platform service through the user terminals 210, 220, 230, and 240. The e-commerce platform service may include overall services required to sell products online, such as product supply, sales, promotion, and purchase.

According to one embodiment, the platform server 100 may provide the supplier with a service necessary to supply products on the platform through the supplier terminal 210.

According to one embodiment, the platform server 100 may register a supplier of a product to be sold in the platform service through the supplier terminal 210. The supplier may be, for example, a person who supplies the product to be sold in the platform service and delivers the product sold by a seller. Accordingly, the supplier may be a person who is only responsible for product distribution and delivery and entrusts the rest to other users. According to one embodiment, registering with the platform service may be understood as registering with the platform service as a participant performing a designated role. According to one embodiment, the supplier may be approved for registration according to a designated criterion. The designated criterion may include, for example, a criterion for determining the reliability of the supplier, such as business period, capital size, sales size, brand value, etc. According to one embodiment, the supplier may be approved according to a strict criterion (or high criterion). Accordingly, the products can be stably supplied on the platform by highly reliable suppliers.

According to one embodiment, the platform server 100 may register supply products of the supplier in the platform service through the supplier terminal 210. According to one embodiment, the product may be approved for registration according to a designated criterion. The designated criterion may include, for example, a criterion for predicting a sales volume of the products, such as product quality, consumer preference, brand involvement, market share, distribution margin structure, and availability of exclusive distribution. According to one embodiment, the product may be approved according to a strict criterion. Accordingly, the products with high sales volume are registered and users (e.g., sellers, content creators) who can contribute to promoting product sales participate more in the platform service, which results in high synergy.

According to one embodiment, the platform server 100 may provide a total solution required to supply the products through the supplier terminal 210. For example, the platform server 100 may provide a solution that includes services for managing registration and sale of the supply products and the community. The service for managing product sales may include, for example, services for providing sales information for the registered supply products, managing inventory of the supply products, and managing order, delivery, and refunds. According to one embodiment, the platform server 100 may provide settlement information for the products sold through an online shop of the seller. According to one embodiment, the platform server 100 may provide a solution required to supply the products through a graphic user interface (GUI).

According to one embodiment, the platform server 100 may provide the service required for product sales to the seller through the seller terminal 220.

According to one embodiment, the platform server 100 may register the seller in the platform service through the seller terminal 220. The seller may be, for example, a person who sells the supply products registered in the platform service by the supplier. According to one embodiment, the sellers may be arranged to form a hierarchy. The hierarchy may, for example, consist of an upper seller and sub-sellers subordinate to the upper seller. According to one embodiment, the sub-seller who is subordinate to the upper seller may be subordinate to the upper seller in terms of products that can be sold and sales conditions, and may be required to pay a portion of the sales amount as a commission to the upper seller. According to one embodiment, the seller may be approved for registration based on a designated criterion. The designated criterion may be applied differently depending on, for example, a stratum of the seller. A top seller may be approved for registration on a strict criterion basis based on reliability equivalent to that of the supplier, such as sales size, capital size, and human network size. The sub-sellers (e.g., second-stratum sellers, third-stratum seller) may be registered in the platform service with the approval of the upper seller. Accordingly, under the direction of a highly reliable top seller, the supply products registered in the platform service can be sold in various ways in professional and several online shops (or online shopping malls).

According to one embodiment, the platform server 100 may register sales products of the seller in the platform service through the seller terminal 220. For example, the platform server 100 may register the sales products of the top seller. In other words, the platform server 100 may allow only the top seller to apply for sales approval of a new product. For example, sub-sellers of the top seller cannot directly apply for sales approval of the new product, but can select and sell a product from within the products approved for sale of the top seller. According to one embodiment, the sales products may be approved according to a designated criterion. The designated criterion of sales products may include, for example, a criterion for determining whether the product can be sold professionally, such as the seller's activity area, capital size, existing sales products, sales size, etc. According to one embodiment, an approval criterion for the sales products may be high. Accordingly, product information about the supply products registered in the platform service is delivered to purchasers who are interested in the product through appropriate marketing methods by professional sellers, thereby recording high sales, thereby capable of bringing high profits not only to suppliers but also to users who contribute to product sales (e.g., sellers, content creators).

According to one embodiment, the platform server 100 may provide a solution for generating an online shop within the platform. For example, the platform server 100 may provide a function to set up the online shop using a drag and drop method through a GUI without hard coding. In addition, the platform server 100 may provide a pre-made design template. According to one embodiment, the platform server 100 may register the sales products of the seller in the online shop. For example, the sales products may be the products that have been approved for sale for the seller. According to one embodiment, the platform server 100 may generate an online shop requested by the seller. For example, the platform server 100 may generate an online shop generated by each seller. Each seller may generate a separate online shop according to his or her preferences. Accordingly, the purchaser may selectively subscribe to the online shop that suits his or her tastes on the platform service and purchases the product registered in the online shop as a member.

According to one embodiment, the platform server 100 may provide a sales service for the products registered in the generated online shop to the user who visits the platform. For example, the platform server 100 may allow the user who directly visits the platform to search for the product through routes within the platform (e.g., search, online shop visit) and purchase the searched product. Information on the product registered in the online shop may, for example, be made unsearchable through a portal service (e.g., Naver, Yahoo). Accordingly, it is possible to increase user loyalty to the platform service and prevent the suppliers and the sellers from bleeding due to excessive competition for the lowest price.

According to one embodiment, the platform server 100 may register the user of the platform service as a new seller. For example, the platform server 100 may register the user other than product suppliers and previously registered sellers as a seller in the hierarchy consisting of a plurality of sellers.

According to one embodiment, the platform server 100 may register the user of the platform service as the seller according to a request from the seller terminal 220. According to one embodiment, when the platform server 100 receives a request for registering a designated user as the seller from the seller terminal 220, the platform server 100 may transmit invitation information to a terminal of the designated user. The terminal of the user may be, for example, a content creator terminal 230 and a purchaser terminal 240. According to one embodiment, the designated user may be registered as the seller in the platform service through the invitation information. According to another embodiment, when the platform server 100 receives a request for register any user as the seller through the seller terminal 220, the platform server 100 may transmit the invitation information to the seller terminal 220. The arbitrary user may include, for example, a user newly participating in the platform service. According to one embodiment, the seller may register the user in the platform service by providing the received invitation information to the user whom the seller wants.

According to one embodiment, the platform server 100 may register the user determined based on usage history information of the platform service as the seller. The usage history information may include, for example, at least one of creation content information of content provided to the platform service and purchase history information. According to one embodiment, the platform server 100 may transmit the invitation information to the determined user's terminal. According to one embodiment, the user may be registered as the seller in the platform service through the received invitation information.

According to one embodiment, the platform server 100 may generate an online shop of the user newly registered as the seller. For example, the online shop may include at least one product registered by the upper seller to whom the user registered as the seller is subordinate.

According to one embodiment, the platform server 100 may invite an operator of an offline shop to the platform service. According to one embodiment, the platform server 100 may register the operator of the offline shop as the seller in the platform service. For example, the platform server 100 may register the operator of the offline shop as the top seller in the hierarchy. According to one embodiment, the platform server 100 may register the products of the offline shop as the sales product in the platform service. For example, the product of the offline shop registered as the sales products may not be registered as the supply product in the platform service. Accordingly, the product of the offline shop can be sold exclusively by the operator registered as the seller. According to one embodiment, the platform server 100 may generate an online shop of the operator registered as the seller. For example, the generated online shop may include the product of the offline shop registered as the sales products.

Accordingly, the platform server 100 may expand the hierarchy consisting of sellers by registering the user of the platform server as the new seller.

According to one embodiment, the platform server 100 may provide a total solution required to sell the products through the seller terminal 220. For example, the platform server 100 may provide a solution that includes services for managing online shop, human resources, registration of the sales products, sales of sales products, and the community of the online shops. The service for managing human resources may include, for example, a service for managing sub-sellers and members. The service for managing the sales of sales products may include services that provide sales information for products sold, and manage orders, delivery, and refunds. According to one embodiment, the platform server 100 may provide settlement information for the product sold through the online shop. According to one embodiment, the platform server 100 may provide state information of the sub-seller subordinate to the upper seller in the hierarchy. The state information may include, for example, information about the human resources, product sales, and community. According to one embodiment, the platform server 100 may provide a solution required for selling products through a GUI.

According to one embodiment, the platform server 100 may provide a service required for supplying content to the supplier through the content creator terminal 230.

According to one embodiment, the platform server 100 may register the content creator in the platform service. For example, the content creator may create content that helps sell the product and provide the created content to the supplier and the seller. According to one embodiment, the content creator may be an expert who is directly or indirectly required to create content. The professional personnel may include, for example, a model, a hair and makeup expert, a stylist, a photographer, etc. In addition, the model may be an influencer or celebrity on online social media.

According to one embodiment, the platform server 100 may provide a service that allows the content created by the content creator to be shared with platform users. For example, the platform server 100 may provide a content sharing service using the platform users as a social network, that is, a social network service (SNS). According to one embodiment, the platform server 100 may register content of the content creator in the platform service. According to one embodiment, the platform server 100 may provide the registered content to the platform users through the content sharing service. The content shared through the content sharing service may be content for promoting the product sold on the platform service. According to one embodiment, the content may include information (e.g., URL) about the online shop within the platform where the product being promoted is sold. Accordingly, the purchaser may move to a designated shopping mall using the information and purchase the product. According to one embodiment, the platform server 100 may provide information about participants who participated in creating the content (e.g., the model, the hair and makeup expert, the stylist, the photographer, etc.) along with the content. Accordingly, the supplier and the purchaser may easily check not only the model but also all parties required for content creation.

According to one embodiment, the platform server 100 may provide a service for connecting the supplier and the seller to the content creator. According to one embodiment, the platform server 100 may connect the supplier and seller who wish to request the creation of content for promoting the product to the content creator. For example, the platform server 100 may connect not only the model matching an image of the product but also participants required for content creation, such as the hair and makeup expert and the stylists, all at once. According to one embodiment, the platform server 100 may connect the supplier who want to sponsor a product and the seller to the content creator. According to one embodiment, the platform server 100 may connect the content creator expected to have a high promotional effect to the supplier and the seller. For example, the platform server 100 may connect the content creator who is expected to have the high promotional effect based on the previously created content, sales of the product of the created content, etc.

According to one embodiment, the platform server 100 may provide a total solution required for supplying content through the content creator terminal 230. For example, the platform server 100 may provide a solution including a service for managing contracts with the supplier and the seller, profits, and settlement. According to one embodiment, the platform server 100 may provide profit information according to content creation. According to one embodiment, the platform server 100 may provide a solution required for supplying content through the GUI.

According to one embodiment, the platform server 100 may provide a service required for purchasing the product to the purchaser through the purchaser terminal 240.

According to one embodiment, the platform server 100 may register the purchaser as a member in the online shop of the seller. For example, the platform server 100 may register the purchaser as a member in the online shop of each seller.

According to one embodiment, the platform server 100 may receive order and delivery information of the purchaser who purchased the product through the online shop. According to one embodiment, the platform server 100 may provide a payment service to the purchaser who purchased the product. According to one embodiment, the platform server 100 may transmit order information to the supplier and the seller when payment is completed. Accordingly, the supplier may deliver the ordered product to the purchaser.

According to one embodiment, the platform server 100 may provide a service for managing an order state through the purchaser terminal 240. According to one embodiment, the platform server 100 may provide order and delivery information for the product purchased from the online shop. According to one embodiment, when the platform server 100 receives order correction information, the platform server 100 may modify the order information based on the received correction information.

According to one embodiment, a manager of the platform server 100 may approve registration of the platform service. According to one embodiment, the manager of the platform server 100 may approve registration of the platform user. For example, the manager may approve registration of the supplier and the seller. The seller for the registration approval may be, for example, the top seller. According to one embodiment, the manager of the platform server 100 may approve registration of the product. For example, the manager may approve the supply products of the supplier and the sales products of the seller. For example, the sales products may sales products of the top seller. According to one embodiment, the manager of the platform server 100 may access the platform server 100 through a separate terminal and approve the registration of the service.

According to one embodiment, the manager of the platform server 100 may check state information for managing an overall state of the supplier and the seller. The state information may include, for example, sales information (e.g., sales information, settlement information, delivery information, etc.), settlement information, and order and delivery information. According to one embodiment, the manager of the platform server 100 may check community information. The community information may include, for example, an online shop, and notices, FAQ, Q&A, reviews, etc. about products sold in the online shop.

According to one embodiment, the platform server 100 may include a database (DB) for data storage as well as a computing module required for providing the e-commerce platform service. In other words, the platform server 100 may include a server configuration generally required for providing the e-commerce service. According to one embodiment, the platform server 100 may provide useful information to the service users by analyzing information stored in the database. The useful information may include, for example, basic data useful for product supply, product sales, content creation, and product purchase, and processed data.

The supplier terminal 210 may be a terminal of the supplier for using the e-commerce platform service provided to the supplier from the platform server 100.

According to one embodiment, the supplier terminal 210 may receive information for managing product supply from the platform server 100. For example, the supplier terminal 210 may receive information for registering supply products, selling supply products, and managing a community for supply products. According to one embodiment, the supplier terminal 210 may transmit information input from the supplier to the platform server 100 in order to manage product supply. For example, the supplier terminal 210 may transmit application information for registering new supply products. In addition, the supplier terminal 210 may transmit information input from the supplier in order to manage ordering, delivery, and community of the supply products. According to one embodiment, the supplier terminal 210 may provide information for managing product supply to the supplier through the GUI and receive information required for managing product supply from the supplier.

The seller terminal 220 may be a terminal of the seller for using the e-commerce platform service provided to the seller from the platform server 100.

According to one embodiment, the seller terminal 220 may receive a service for generating a shopping mall provided from the platform server 100. The service for generating the online shop may include information required for generating the shopping mall, for example, in a way of dragging and dropping through the GUI and providing a template. According to one embodiment, the seller terminal 220 may transmit information input from the seller to the platform server 100 in order to generate the online shop. Accordingly, the online shop of the seller may be generated on the platform.

According to one embodiment, the seller terminal 220 may receive information for managing product sales from the platform server 100. For example, the seller terminal 220 may receive information for managing registration of sales products, sales of sales products, managing human resources, and managing the community of the online shop. The human resource management may include, for example, managing the sub-seller and the member. According to one embodiment, the seller terminal 220 may transmit information input from the seller to the platform server 100 in order to manage product sales. For example, the seller terminal 220 may transmit an application for registering a new sales product. The application for the new sales product may be made, for example, by the top seller. In addition, the seller terminal 220 may transmit information input from the seller in order to manage the order, delivery, and community of supply products. According to one embodiment, the seller terminal 220 may provide information for managing product supply to the seller through the GUI and receive information required for managing product sales from the seller.

The content creator terminal 230 may be the seller terminal for using the e-commerce platform service provided to the content creator from the platform server 100.

According to one embodiment, the content creator terminal 230 may receive a service for sharing content with the platform users from the platform server 100. The service by which the content can be shared may be, for example, SNS that uses the platform users as a social network. According to one embodiment, the content creator terminal 230 may transmit the created content to the platform server 100. Accordingly, the content of the content creator may be shared on the platform.

According to one embodiment, the content creator terminal 230 may receive a content creation request and sponsorship provision information from the platform server 100. According to one embodiment, the content creator terminal 230 may transmit a response accepting the creation request and sponsorship provision to the platform server 100. Accordingly, content creation or sponsorship contract with the supplier or seller may be concluded.

According to one embodiment, the content creator terminal 230 may receive information for managing the content creation from the platform server 100. For example, the content creator terminal 230 may receive contract information, profit information, and settlement information from the platform server 100. According to one embodiment, the creator terminal 220 may provide the received information to the seller through the GUI and receive information required for managing the content creation and sponsorship contract from the content creator.

The purchaser terminal 240 may be a purchaser terminal for using the e-commerce platform service provided to the purchaser from the platform server 100.

According to one embodiment, the purchaser terminal 240 may receive online shop information. According to one embodiment, the purchaser terminal 240 may transmit order information of a consumer. Accordingly, a product purchase may be made.

According to one embodiment, the user terminals 210, 220, 230, and 240 may be general-purpose devices such as desktop personal computers (PCs), notebook PCs, smartphones, tablet PCs, and personal digital assistants (PDAs). For example, the supplier terminal 210, the seller terminal 220, and the user terminal 230 may be electronic devices having relatively low portability, such as desktop PCs and notebook PCs, and the purchaser terminal 240 may be the smartphone 240b as well as the desktop PC 240a having low portability.

The e-commerce environment 10 described above may provide the e-commerce platform service in which the suppliers who supply products, the sellers who generate online shops to sell the products, and creators who create content to promote the products coexist on one platform, the products are sold to the purchasers, and profits from product sales are shared.

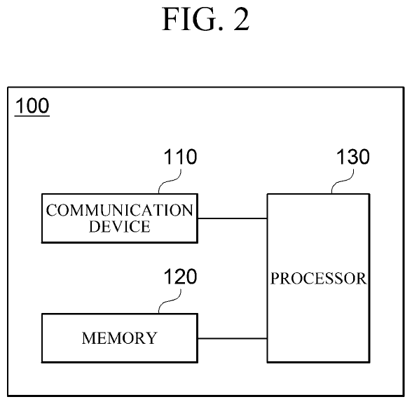

FIG. 2 is a diagram illustrating a configuration of the e-commerce platform server according to an embodiment.

Referring to FIG. 2, the platform server 100 may include a communication device 110, a memory 120, and a processor 130. However, not all of the illustrated components are essential components. The platform server 100 may be implemented with more components than the illustrated components, and the platform server 100 may be implemented with fewer components than the illustrated components.

The communication device 110 may communicate with an external device. For example, the communication device 110 may be connected to a network in a wired manner or wirelessly to communicate with the external device. Here, the external device may be a user terminal (e.g., the user terminals 210, 220, 230, and 240 of FIG. 1).

The communication device 110 may include a communication module that supports one of various wired and wireless communication methods. The communication module may be a short-distance communication module or a wired communication module.

The memory 120 may include at least one type of storage medium among flash memory type, hard disk type, multimedia card micro type, card type memories (SD, XD memory, etc.), semiconductor memories such as a random access memory (RAM), static random access memory (SRAM), read-only memory (ROM), electrically erasable programmable read-only memory (EEPROM), and programmable read-only memory (PROM), a magnetic disk, and an optical disk.

The memory 120 may store at least one program for providing e-commerce platform service, in which users for product supply, product sales, content provision, and product purchase participate, from the platform server 100. At least one program stored in the memory 1020 may be classified into a plurality of modules according to functions.

The memory 120 may include DBs for registering information on the products, suppliers, sellers, content creators, and purchasers. However, each of the DBs is a separate storage device and may be implemented outside of the platform server 100 and connected thereto directly or through a communication network.

The processor 130 controls the overall operation of the platform server 100 and may include at least one processor such as a CPU. The processor 130 may include at least one specialized processor corresponding to each function, or may be an integrated processor.

The processor 130 may execute a program stored in the memory 120, read data or files stored in the memory 120, or store a new file in the memory 120. In addition, the processor 130 may execute instructions stored in the memory 120. Accordingly, the processor 130 may perform the following operations.

The operation performed by executing the instructions by the processor 130 may be understood as an operation of the platform server (e.g., platform server 100 of FIG. 1).

According to one embodiment, the processor 130 may register the supplier of the product to be sold in the platform service in a supplier DB through a supplier terminal (e.g., supplier terminal 210 of FIG. 1). According to one embodiment, being registered in the DB may be understood as storing information on a target to be registered. In addition, storing target information in the DB may be understood as registering the target in the platform service.

According to one embodiment, the processor 130 may receive application information for registering as the supplier from the supplier terminal. The application information may include, for example, supplier information that can identify the supplier and determine whether or not to register the supplier the supplier.

According to one embodiment, the processor 130 may determine whether or not to register the supplier based on a response of the manager of the platform service. Whether or not to register the supplier may be determined based on a designated criterion that can determine, for example, the reliability of the supplier. According to another embodiment, the processor 130 may determine whether or not to register the supplier based on the designated criterion. For example, the processor 130 may automatically determine whether or not to register the supplier based on a criterion stored in the memory 120. According to one embodiment, the processor 130 may register the supplier in the supplier DB according to the determination of whether or not to register the supplier.

According to one embodiment, the processor 130 may register the supply product in the supply products DB through the supplier terminal. The supply product may be, for example, the product of the supplier product to be sold on the platform service. According to one embodiment, the processor 130 may receive application information for registering the supply product from the supplier terminal. For example, the application information may include supply product information that can identify the supply product and determine whether or not the supply product is registered. According to one embodiment, the processor 130 may determine whether or not to register the supply product based on a response of the manager of the platform service. Whether or not to register the supply product may be determined, for example, based on a designated criterion that can predict the sales volume of the product. According to another embodiment, the processor 130 may determine whether or not to register the supply product based on the designated criterion. For example, the processor 130 may automatically determine whether or not to register the supply product based on a criterion stored in the memory 120. According to one embodiment, the processor 130 may register the supply product in the supply products DB according to the determination of whether or not to register the supply product.

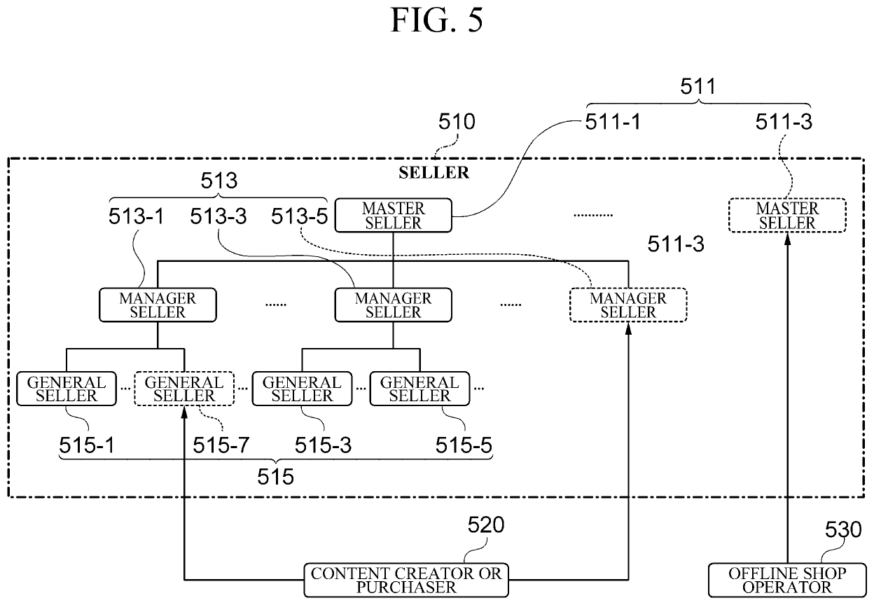

According to one embodiment, the processor 130 may register the seller in the seller DB through the seller terminal (e.g., seller terminal 220). For example, when registering a plurality of sellers in the seller DB, the processor 130 may register the plurality of sellers in the seller DB in the hierarchy consisting of the upper seller and at least one sub-seller subordinate to the upper seller. According to one embodiment, the processor 130 may register the top seller in the hierarchy as a master seller in the seller DB, and register the sub-sellers subordinate to the top seller as manager sellers and general sellers subordinate to the manager sellers in the seller DB. According to one embodiment, the processor 130 may grant designated authority to the manager seller so as to manage the general sellers. The hierarchy will be described in more detail in FIG. 5.

According to one embodiment, the processor 130 may receive application information for registering as the seller from the seller terminal. For example, the application information may include seller information that can identify the seller and determine whether or not to register the seller.

According to one embodiment, the processor 130 may determine whether or not to register the top seller based on a response to the manager of the platform service. For example, the processor 130 may provide the received product information to the manager and determine whether or not to register as the top seller according to whether or not the manager approves the top seller. Whether or not to register the top seller may be determined, for example, based on a designated criterion that can determine the reliability of the seller. The designated criterion may be a predetermined criterion in order to objectively determine the reliability of the seller.

According to one embodiment, the processor 130 may determine whether or not to register a sub-seller who is subordinate to the upper seller based on a response of the upper seller. For example, the processor 130 may transmit the information on the sub-seller to the terminal of the upper seller to whom the sub-seller is subordinate, receive a response determining whether or not to register from the terminal of the upper seller, and determine whether or not to register the sub-seller according to the received response. For example, whether or not to register the sub-seller may be determined based on a subjective criterion of the top seller, different from the top seller. According to another embodiment, the processor 130 may determine whether or not to register the seller based on a designated criterion. For example, the processor 130 may automatically determine whether or not to register the seller based on the criterion stored in the memory 120. According to one embodiment, the processor 130 may register the seller in the seller DB according to the determination of whether or not to register.

According to one embodiment, the processor 130 may register the sales products in the sales products DB through the seller terminal. For example, the processor 130 may register the sales products of the top seller in the sales products DB. For example, the sales products may be at least one of the supply products registered in the supply products DB. In other words, at least one of the supply products registered by the supplier may be selected and registered as the sales product.

According to one embodiment, the processor 130 may receive application information for registering the sales products from the top seller terminal. The application information may include, for example, sales product information that can identify the product, and seller information required for determining whether or not to register the sales products. According to one embodiment, the processor 130 may determine whether or not to register the sales products based on the response of the platform service manager. For example, whether or not to register the sales products may be determined based on the criterion for determining whether or not the products can be sold professionally.

According to one embodiment, the processor 130 may allow sub-sellers subordinate to the top seller to sell the products within the registered sales products of the top seller. In other words, the sales products of the sub-sellers are subordinate to the registered sales products of the top seller to whom the sub-sellers are subordinate. In addition, the sub-sellers cannot request registration of separate sales products. According to another embodiment, the processor 130 may determine whether or not to register the sales products according to a designated criterion. For example, the processor 130 may automatically determine whether or not to register the sales products based on the criterion stored in the memory 120. According to one embodiment, the processor 130 may register the sales product in the sales products DB according to the determination of whether or not to register.

According to one embodiment, the processor 130 may provide a solution for generating the online shop within the platform through the seller terminal. According to one embodiment, the processor 130 may receive a user input for setting up the online shop from the seller terminal. The user input may be, for example, dragging and dropping the configuration of the online shop to a designated location through the GUI. In addition, the user input may be input based on a pre-made design template. According to one embodiment, the processor 130 may generate an online shop in which at least one of the products registered in the sales products DB is registered based on the received user input. According to one embodiment, the processor 130 may generate the online shop for each of a plurality of sellers. For example, the processor 130 may generate the online shop of the sub-seller subordinate to the top seller. For example, the generated online shop may include at least one of the registered sales products of the top seller registered in the sales products DB. In addition, it is possible to generate an online shop of the top seller as well as the sub-seller.

According to one embodiment, the processor 130 may set a profit rate for distributing the profits of the products sold through the seller terminal. According to one embodiment, the processor 130 may receive information for setting the profit rate of the seller according to the hierarchy from the terminal of the top seller. For example, when receiving information for setting the profit rate of the top seller, the processor 130 may recommend the profit rate of the sub-seller subordinate thereto. According to one embodiment, the processor 130 may set the profit rate for the sellers in the hierarchy according to the received information for setting the profit rate. For example, when receiving the input of the top seller who agrees with the recommended profit rate, the processor 130 may set the profits of the sellers in the hierarchy according to the recommended profit rate.

According to one embodiment, the processor 130 may register the user of the platform service as a seller in the hierarchy consisting of a plurality of sellers in the seller DB. For example, the processor 130 may register users newly participating in the platform service, including a content creator who creates content for promoting the sales products, and a purchaser who purchases the product through the online shop as well as an operator of the offline shop in the platform service, as the sellers in the seller DB. The hierarchy consisting of the plurality of sellers may consist of, for example, a top seller and at least one sub-sellers subordinate to the top seller.

According to one embodiment, the processor 130 may provide invitation information for registering the user of the platform service as the seller in the hierarchy. For example, the invitation information may include link information (e.g., QR code) for accessing a registration page of the seller in the platform service.

According to one embodiment, the processor 130 may provide the invitation information in response to a request from at least one terminal among the plurality of sellers included in the hierarchy.

According to one embodiment, the processor 130 may transmit the invitation information to the terminal of the user to be registered as the seller in response to the request from at least one terminal among the plurality of sellers included in the hierarchy. For example, when receiving a request for registering a designated user as the seller from the terminal of the seller, the processor 130 may transmit the invitation information to the terminal of the designated user. According to one embodiment, the processor 130 may provide consulting information for recommending the designated user to at least one terminal among the plurality of sellers, based on usage history information of the platform service. For example, based on the usage history information, the processor 130 may provide consulting information for recommending a user who is expected to increase sales of the sales products when the user is registered as the sub-seller. The usage history information may include, for example, at least one of creation history information of content for promoting the sales products on the platform service, and purchase history information. According to one embodiment, the processor 130 may receive a request for invitation information for registering the designated user as the seller from the terminal of the seller who provided the consulting information. According to one embodiment, the processor 130 may transmit the invitation information to the terminal of the designated user in response to the received request.

According to another embodiment, the processor 130 may transmit the invitation information to the terminal of the seller in response to a request from at least one terminal among the plurality of sellers included in the hierarchy. For example, when the processor 130 receives a request of the seller for inviting any user from the seller, the processor 130 may transmit the invitation information to the terminal of the seller who requested the invitation information. Accordingly, the seller in the hierarchy may register a user desired by the seller as the seller in the platform service by providing the user with the invitation information received on the terminal.

According to one embodiment, any user may include a user newly participating in the platform service. For example, the random user may include an existing user (e.g., content creator and purchaser) as well as the newly participating user. According to one embodiment, even if the person the seller wants to newly participate in the platform service is not the existing user, there may be a high possibility that the existing seller will invite the user who can be managed due to the hierarchy of the plurality of sellers and who has a certain level of expertise secured due to the nature of sharing profits. Even if a user without expertise is invited, the manager of the platform server can determine whether or not to approve by reviewing the qualifications thereof, and thus the registration of the user without expertise may be prevented.

According to one embodiment, the processor 130 may receive application information for registering as the seller from the terminal of the user of the platform service through the invitation information. For example, the processor 130 may receive the application information from the terminal of the designated user through invitation the information directly transmitted to the terminal of the designated user according to the request of the seller. For another example, the processor 130 may receive the application information from the terminal of the user of the platform service through the invitation information delivered from the terminal of the seller who requested the invitation information.

According to one embodiment, the processor 130 may register the user in the seller DB as a seller in the hierarchy of the plurality of sellers based on the received application information. For example, the application information may include seller information that can determine whether or not to register the seller. According to one embodiment, the processor 130 may execute a required process according to a stratum in which the user is to be registered. For example, when the processor registers the user as the seller through the invitation information provided in response to the request from the seller in the hierarchy, the processor 130 may not require approval from the seller who requested the invitation information.

According to one embodiment, the processor 130 may register the user to be registered as the seller in the hierarchy through invitation information requested from the seller registered in the hierarchy as a subordinate seller subordinate to the seller who requested the invitation information. For example, the processor 130 may register the user as a sub-seller directly subordinate to the seller who requested the invitation information, or as a sub-seller indirectly subordinate thereto through another sub-seller subordinate to the seller who requested the invitation information, based on the usage history information of the platform service of the user. In other words, the processor 130 may basically register the user as the sub-seller directly subordinate to the seller who requested the invitation information. However, the processor 130 may register the user as the sub-seller indirectly subordinate to the seller through another sub-seller if the determination based on the usage history information indicates that it is more appropriate for the user to be indirectly subordinate thereto.

According to another embodiment, the processor 130 may transmit the invitation information to the terminal of the user determined based on the usage history information of the platform service.

According to one embodiment, the processor 130 may determine the user to be registered as a sub-seller subordinate to a designated upper seller in the hierarchy based on the usage history information of the platform service. The usage history information may include, for example, at least one of creation history information of content for promoting sales products on the platform service, and purchase history information. According to one embodiment, the processor 130 may transmit the invitation information to the terminal of the determined user. According to one embodiment, the processor 130 may provide consulting information including information on the designated upper seller and the invitation information based on the usage history information of the platform service. For example, the processor 130 may provide consulting information including information on the upper seller who is expected to have high profits shared depending on product sales when the user is registered as the sub-seller based on the usage history information.

According to one embodiment, the processor 130 may receive application information from the terminal of the determined user through the invitation information. According to one embodiment, the processor 130 may register the user in the seller DB as the sub-seller subordinate to the designated upper seller. According to one embodiment, the processor 130 may execute a process required for the stratum in which the user is registered. For example, the processor 130 may request approval of the upper seller to whom the user is subordinate as the seller. According to one embodiment, when receiving the approval from the terminal of the upper seller, the processor 130 may register the user in the seller DB as the seller of the determined stratum.

According to one embodiment, the processor 130 may generate an online shop of the user registered as the seller. For example, the online shop may include at least one of the sales products registered in the sales products DB by the top seller in the hierarchy.

According to one embodiment, the processor 130 may register at least one of the content creator, who provides content to the platform service for promoting the sales products of the platform service, and the purchaser, who purchases the product through the online shop of the platform service, as the seller in the hierarchy in the seller DB.

According to one embodiment, the processor 130 may register an operator of the offline shop, who is the user of the platform service, as a seller in the hierarchy in the seller DB. For example, the operator of the offline shop may be the user who is in a cooperative relationship with the platform service in order to sell the product of the offline shop through the platform service. According to one embodiment, the processor 130 may register the operator of the offline shop as the top seller in the hierarchy in the seller DB. For example, the processor 130 may register the operator of the offline shop as the master seller in the seller DB.

According to one embodiment, the processor 130 may register the product sold in the offline shop in the sales products DB. For example, the processor 130 may register the product sold in the offline shop in the sales products DB according to authority information of the operator registered as the master seller in the hierarchy. For example, the products of the offline shop registered as the sales product may not be registered in the supply products DB as the supply product. Accordingly, only the seller subordinate to the operator of the offline shop can sell the product of the offline shop.

According to one embodiment, the processor 130 may generate an online shop, which includes the product of the offline shop registered as the sales product, of the operator. Accordingly, the online shop corresponding to the offline shop may be generated on the platform service.

According to one embodiment, the processor 130 may provide invitation information of the operator that can be displayed in the offline shop through the terminal of the operator. According to one embodiment, the processor 130 may register a visitor of the offline shop as a participant in the platform service through the invitation information of the operator. For example, when the visitor of the offline shop accesses the platform server through the invitation information of the operator, the processor 130 may register the visitor as a member of the online shop of the operator. For another example, when the visitor accesses the platform server through the invitation information, the processor 130 may provide recommendation information for at least one of a plurality of online shops on the platform service based on purchase history at the offline shop. For another example, when the visitor accesses the platform server through the invitation information, the processor 130 may register the visitor in the seller DB as a sub-seller subordinate to the operator who is registered as the seller.

According to one embodiment, the processor 130 may register the content creator in the content creator DB through a content creator terminal (e.g., the content creator terminal 230 of FIG. 1). According to one embodiment, the processor 130 may receive application information for registering as the content creator from the content creator terminal. The application information may include, for example, information for identifying the content creator. According to one embodiment, the processor 130 may register the content creator based on the received application information. The content creator may be, for example, an expert directly or indirectly required to create content.

According to one embodiment, the processor 130 may provide a service for sharing the content with the platform users through the content creator terminal. According to one embodiment, the processor 130 may receive the content for promoting the product registered in at least one of the supply products DB and the sales products DB from the content creator terminal. According to one embodiment, the processor 130 may register the received content in a content DB. According to one embodiment, the processor 130 may provide the content registered in the content DB to the platform user. For example, the processor 130 may provide the purchaser with the content uploaded to a space where the content creator can be identified through the terminal of the purchaser. The content may be, for example, requested by the supplier or the seller through the platform service.

According to one embodiment, the processor 130 may provide a service for connecting the supplier and seller to the content creator through the content creator terminal. For example, the processor 130 may request the creation of content for promoting the product, or connect the supplier and seller to the content creator for sponsoring the product. According to one embodiment, the processor 130 may upload the connected content to the online shop of the seller and provide the content to the user of the platform service. For example, the processor 130 may provide a product purchase page, in which the content is uploaded, through the purchaser terminal.

According to one embodiment, the processor 130 may provide recommendation information about the content creator expected to have a high promotional effect through the supplier terminal and the seller terminal. The recommended information may be provided, for example, based on information on the content that has been created.

According to one embodiment, the processor 130 may provide the service required for purchasing the product to the purchaser through the purchaser terminal (e.g., the purchaser terminal 240 of FIG. 1). According to one embodiment, the processor 130 may receive purchase information of the purchaser who purchased the product from the purchaser terminal. According to one embodiment, the processor 130 may transmit the received order information to the supplier terminal and the seller terminal when payment is completed. For example, the processor 130 may transmit the received order information to the supplier terminal and allow the supplier to deliver the product to the purchaser.

Accordingly, the e-commerce platform server 100 can provide the platform service for selling the products online.

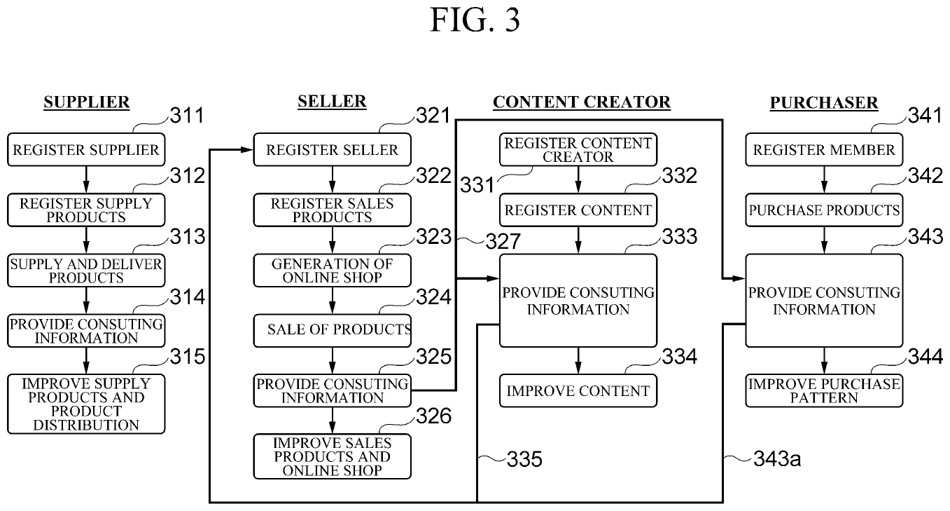

FIG. 3 is a flowchart illustrating a process in which the content creator and the purchaser are registered as new sellers in the e-commerce platform service according to an embodiment.

Referring to FIG. 3, the user of the e-commerce platform service may be registered as the seller of the product through a process of selling the product, creating the content, and purchasing the product.

According to one embodiment, the supplier who is the user of the platform service may supply the product to the seller. For example, the supplier may supply the product to the existing sellers registered in the platform service and to a user to be newly registered. According to one embodiment, the supplier may be registered as a supplier supplying the products to the platform service through the supplier terminal (311) (e.g., supplier terminal 210 of FIG. 1) (311). According to one embodiment, the registered supplier may register the supply products through the supplier terminal (312). According to one embodiment, the supplier may supply the product to the seller of the platform service and deliver the product sold through the online shop of the seller (313).

According to one embodiment, the platform server (e.g., platform server 100 of FIG. 1) may provide consulting information to the supplier based on usage history information of the supplier (314). For example, the platform server may provide the consulting information on the type, inventory, delivery, etc. of the supply products based on the usage history information of the supplier. For example, the usage history information may be information accumulated in a process of the supplier supplying and delivering the products on the platform service. According to one embodiment, the supplier may improve the supply products and distribution of products through the consulting information (315).

According to one embodiment, the supplier may use the platform service centered on his or her role of supplying the products. For example, it may be difficult for the supplier to register as the seller in the hierarchy based on the recommendation of the existing seller. In other words, the supplier may not be involved in selling the products in accordance with the purpose of this service, which is intended to entrust product sales to professional sellers and focus only on product distribution.

According to one embodiment, the seller who is the user of the platform service may sell the registered supply products through the online shop. For example, a plurality of sellers may form the hierarchy and sell the products through the online shop according to a main role of the stratum thereof. According to one embodiment, the seller may register as a seller selling the product in the platform service through the seller terminal (e.g., seller terminal 220 of FIG. 1) (321). For example, the registered seller may sell the products in a plurality of stratums. According to one embodiment, the seller may register the sales products through the seller terminal (322). For example, the top seller of the hierarchy may register at least one of the supply products as the sales products. According to one embodiment, the seller may generate the online shop that includes at least one of the registered sales products (323). According to one embodiment, the seller may sell the products through the generated online shop (324).

According to one embodiment, the platform server may provide consulting information to the seller based on usage history information of the seller (325). For example, the platform server may provide consulting information on the type of sales products, sales history, layout of the online shop, etc. based on the usage history information of the seller. For example, the usage history information may be information accumulated in a process of the seller selling the products on the platform service. According to one embodiment, the seller may improve the sales products and the online shop through the consulting information (326).

According to one embodiment, the platform server may provide recommendation information for the user to be registered as the seller through the consulting information. For example, the platform server may provide the recommendation information including information about the user to be registered as the seller. The user to be registered as the seller may be, for example, a user who can increase sales of the sales products, and may be the content creator who provides content to the platform service, and the purchaser who purchases the product through the online shop. According to one embodiment, the platform server may provide the recommendation information of the user to the seller based on usage history information of the platform service. The usage history information of the user may include, for example, history information on the creation of content for promoting the sales products of the seller and purchase history information. According to one embodiment, the content creator who has created the content for promoting the sales products and the purchaser who has purchased the sales products may have a higher understanding of not only the products they directly create or purchase, but also other sales products of the seller, compared to other users. This is because the sales products of the seller may be highly related to each other because the sales products are determined based on the criterion based on expertise, such as, for example, an activity area of the seller. Accordingly, the platform server may increase future sales by recommending the user having a high level of understanding of the sales product to the seller.

According to one embodiment, the seller may request the platform server to invite a platform user as the seller through the recommendation information. According to one embodiment, the platform server may provide invitation information to the user of the platform service according to the request of the seller (327). For example, the platform server may transmit the invitation information to the content creator and the purchaser according to the request of the seller. Accordingly, the content creator and the purchaser may be registered as the sellers through the invitation information.

According to one embodiment, the content creator who is the user of the platform service may provide the content for promoting the sales products in the platform service. For example, the content creator may provide promotional content to the seller or upload the promotional content to a space where he or she may be identified on SNS services. According to one embodiment, the content creator may be registered as a content creator providing content in the platform service through the content creator terminal (e.g., content creator terminal 230) (331). According to one embodiment, the content created by the registered content creator may be registered in the platform service (332). The registered content may be, for example, content created by being requested by the seller or by sponsoring the products.

According to one embodiment, the platform server may provide consulting information to the content creator (333) based on usage history information of the content creator. For example, the platform server may provide consulting information on the type and contents of the content based on the usage history information of the content creator. For example, the usage history information may be information accumulated in a process of providing the content by the content creator on the platform service. According to one embodiment, the content creator may improve the content through the consulting information (334).

According to one embodiment, the platform server may provide invitation information for registering as a seller to the content creator to be registered as the seller through the consulting information. According to one embodiment, the platform server may provide consulting information including information of an upper seller to whom the content creator is subordinated as a sub-seller and invitation information. For example, the content creator to whom the invitation information is provided may be the user who can increase sales of the sales products of the upper seller to whom the content creator is subordinated. According to one embodiment, the platform server may provide the invitation information of the content creator to the content creator based on the usage history information of the content creator. For example, the usage history information of the content creator may include history information on the creation of the content for promoting the sales products of the seller. Accordingly, the platform server may increase future sales by registering the content creator who have a higher understanding of the sales products than other users.

According to one embodiment, the content creator may apply to the platform server in order to be registered as the seller through the invitation information (335). According to one embodiment, the platform server may register the content creator, as a seller in the hierarchy, in the platform service in response to the application of the content creator. For example, the platform server may register the content creator in the platform service as the sub-seller subordinate to the upper seller determined based on the usage history information of the content creator.

According to one embodiment, the purchaser who is the user of the platform service may purchase the products through the online shop. According to one embodiment, the purchaser may be registered as a member of the platform service through the purchaser terminal (e.g., the purchaser terminal 240 of FIG. 1) (341). According to one embodiment, the purchaser may purchase a desired product through the online shop on the platform service (342).

According to one embodiment, the platform server may provide consulting information to the purchaser based on usage history information of the purchaser (343). For example, the platform server may provide the consulting information on the type of purchased product, ordering method, etc. based on the usage history information of the purchaser. For example, the usage history information may be information accumulated in a process of the purchaser purchasing the products on the platform service. According to one embodiment, the purchaser may improve a purchase pattern through the consulting information (344).

According to one embodiment, the platform server may provide invitation information for registering as a seller to the purchaser through the consulting information. According to one embodiment, the platform server may provide the purchaser with the consulting information including information on the upper seller to whom the purchaser will be subordinate as a sub-seller, and invitation information. The content creator to whom the invitation information is provided may be, for example, a user who can increase sales of the sales products of the upper seller to whom the content creator is subordinated. According to one embodiment, the platform server may provide invitation information on a purchaser to the purchaser based on usage history information of the purchaser. The usage history information of the purchaser may include, for example, purchase history information of the products. Accordingly, the platform server may increase future sales by registering the purchaser who has a higher understanding of the sales products than other users.

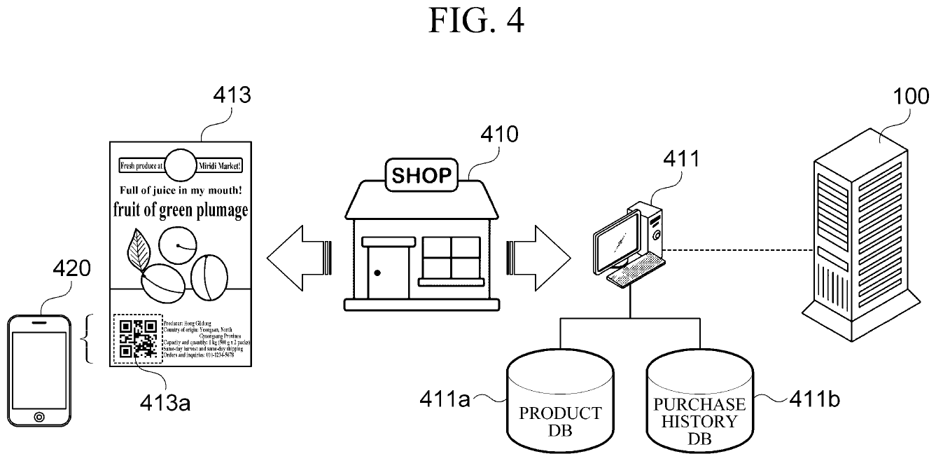

FIG. 4 is a diagram illustrating registering the operator of the offline shop as a new seller in the e-commerce platform service according to an embodiment.

Referring to FIG. 4, the operator of an offline shop 410 may be registered as a seller of the e-commerce platform service.

According to one embodiment, the operator of the offline shop 410, who is the user of the platform service, may be registered as the seller in the service of the platform server 100. According to one embodiment, the operator of the offline shop 410 may be a platform service user who is in a cooperative relationship with the platform service. According to one embodiment, the manager of the platform server 100 (or separate public relations personnel) may establish a cooperative relationship with the offline shop 140 online and help the operator of the offline shop 410 sell the products online.

According to one embodiment, the platform server 100 may register the operator of the offline shop 410 as a seller in the platform service. According to one embodiment, the platform server 100 may transmit invitation information for registering the operator as the seller of the platform service to a terminal 411 of the operator of the offline shop 410. According to one embodiment, the operator of the offline shop 410 may be registered as the seller in the platform service through the received invitation information. For example, the operator of the offline shop 410 may be registered as the top seller in the hierarchy consisting of a plurality of sellers.

According to one embodiment, the platform server 100 may register the products of the offline shop 410 as sales products in the platform service. For example, the platform server 100 may register the products stored in a product DB 411a of the offline shop as the sales products in the platform service through the terminal of the operator. For example, the registered sales products may be sales products of the operator of the offline shop 410 registered as the top seller. Accordingly, except for the sub-seller subordinate to the operator of the offline shop 410, it may be difficult for other sellers to sell the products of the offline shop 410.

According to one embodiment, the platform server 100 may generate a catalog (or pamphlet) containing the registered products of the offline shop 410. For example, the catalog may include information about the registered products (e.g., product image, product description, etc.) of the offline shop 410. According to one embodiment, the platform server 100 may provide the generated catalog through the terminal 411 of the operator of the offline shop 410. For example, the catalog provided to the offline shop 410 may include link information (e.g., QR code) that leads to each product page where the sales products of the online shop of the operator of the offline shop 410 can be purchased. According to one embodiment, the operator of the offline shop 410 may provide the provided catalog to the visitor of the offline shop 410. For example, the operator may output the provided catalog and provide the output catalog to the visitor of the offline shop 410. According to one embodiment, the platform server 100 may provide the generated catalog to the sub-seller subordinate thereto. The sub-seller may, for example, select the product of the sales products to be sold in the online shop through the provided catalog.

According to one embodiment, the platform server 100 may generate the online shop for the operator of the offline shop 410. In other words, the platform server 100 may generate the online shop corresponding to the offline shop 410. The generated online shop may include the products of the offline shop 410.

According to one embodiment, the platform server 100 may provide invitation information 413a through the terminal 411 of the operator of the offline shop 410. For example, the invitation information may include link information (e.g., QR code) to perform a designated operation. According to one embodiment, the platform server 100 may allow a visitor who accesses through the link information to participate in the platform service. For example, the platform server 100 may register the visitor as a member of the online shop of the operator. For another example, the platform server 100 may provide recommendation information for at least one of a plurality of online shops on the platform service based on purchase history information of the visitor stored in a purchase history DB 411b in the offline shop 410. The online shop included in the recommendation information may be, for example, a shop that sells a product similar to the product purchased by the visitor, or a product in the same category as the similar product. For another example, the platform server 100 may register the visitor as a sub-seller subordinate to the operator registered as the seller. The visitor to the offline shop 410 has a higher understanding of the products of the offline shop 410 than other users, and thus, for example, if the visitor is registered as the sub-seller of the operator, the visitor may be helpful in products sales. Accordingly, the visitor to the offline shop 410 may be naturally allowed to participate in the platform.

According to one embodiment, the operator may provide the provided invitation information 413a to the visitor at the offline shop 410. For example, the operator may print guide information 413 including the provided invitation information 413a and place the guide information 413 in the offline shop 410 (e.g., checkout counter of offline shop 410).

According to one embodiment, when the visitor accesses the platform server 100 through the invitation information, the platform server 100 may register the visitor as the sub-seller subordinate to the operator registered as the seller. Accordingly, future sales can be increased through the visitor to the offline shop 410.

FIG. 5 is a diagram illustrating that the user who is registered as a new seller in the e-commerce platform service is registered in a hierarchy consisting of the sellers according to an embodiment.

Referring to FIG. 5, the user of the e-commerce platform service may be registered as a seller in the hierarchy consisting of a plurality of sellers 510.

According to one embodiment, the hierarchy of the sellers 510 may consist of the upper seller and sub-sellers subordinate to the upper seller. The fact that the sub-seller is subordinate to the upper seller may mean that the authority of the sub-sellers within the platform service is subordinate to the authority of the upper seller. In other words, the fact that the sub-seller is subordinate to the upper seller may mean that the authority of the sub-sellers may be determined within the authority of the upper seller. The authority may, for example, be one relating to a scope that may be determined when the seller sells the product by being registered in the platform service, such as whether or not the seller is registered, sales products, sales conditions, etc.

According to one embodiment, the hierarchy of the sellers 510 may consist of a plurality of stratums. For example, each of the plurality of stratums may be sequentially subordinated to an upper stratum. According to one embodiment, the hierarchy of the sellers 510 may consist of a master seller 511, a manager seller 513, and a general seller 515.

According to one embodiment, the master seller 511 may be the top seller in the hierarchy. According to one embodiment, registration of the master seller 511 may be determined by the manager of the platform service. According to one embodiment, the manager may determine whether or not to register the master seller 511 according to on an objective criterion based on reliability. According to one embodiment, the master seller 511 whose registration has been determined by the manager may be registered in the platform service.

According to one embodiment, the master seller 511 may register sales products in the platform service. According to one embodiment, registration of the sales products may be determined by the manager of the platform service. According to one embodiment, the manager may determine whether or not to register the sales products according to an objective criterion based on whether the sales products can be sold professionally. According to one embodiment, the master seller 511 may apply for registration of the sales products for each category of products. The category of products may include a plurality of products, for example, fashion, household goods, sports goods, etc. According to one embodiment, the sales products whose registration is determined by the manager may be registered in the platform service. The registered sales products may be managed in a catalog format. The catalog may be provided to the sub-seller. According to one embodiment, the sales products whose registration is determined by the manager may be registered in the platform service.

According to one embodiment, the master seller 511 may generate an online shop of which the sales products are registered.

According to one embodiment, the master seller 511 may manage the sub-seller (or, manager seller 513 and general seller 515) subordinate thereto. According to one embodiment, the master seller 511 may set the profit rate for the sub-sellers 513 and 515. According to one embodiment, the master seller 511 may determine whether or not to register the sub-sellers 513 and 515. For example, the master seller 511 may determine whether or not to register not only the manager seller 513 but also the general seller 515 subordinate to the manager seller 513.

Accordingly, the master seller 511, as the top seller in the hierarchy, may play the main role of managing the registration of the sales products, also sell the products directly, and manage the sub-sellers 513 and 515.

According to one embodiment, the manager seller 513 may be an intermediate seller in the hierarchy. According to one embodiment, registration of the manager seller 513 may be determined by the master seller 511. According to one embodiment, the registration of the manager seller 513 may be determined according to the subjective criterion of the master seller 511. According to one embodiment, the manager seller 513 whose registration is determined by the master seller 511 may be registered in the platform service as the seller subordinate to the master seller 511. According to one embodiment, the registration of the manager seller 513 may require additional approval from the manager of the platform service.

According to one embodiment, the manager seller 513 can sell the product within the registered sales products of the master seller 511. According to one embodiment, the manager seller 513 may generate an online shop including at least one of the registered products of the master seller 511.

According to one embodiment, the manager seller 513 may manage the sub-seller (or general sellers 515) subordinate thereto. According to one embodiment, the manager seller 513 may determine whether or not to register the sub-seller 515 and check the sales state, delivery state, and settlement state of the sub-seller 515.

Accordingly, the manager seller 513, as the intermediate seller in the hierarchy, may plays a main role of managing the general seller 515 (intermediate manager role), and also sell the product directly.

According to one embodiment, the general seller 515 may be a bottom seller in the hierarchy. According to one embodiment, registration of the general seller 515 may be determined by the upper sellers (or master seller 511 and manager seller 513) of the platform service. According to one embodiment, the general seller 515 whose registration is determined by the upper sellers 511 and 513 may be registered in the platform service. According to one embodiment, the registration of the general seller 513 may require additional approval from the manager of the platform service.

According to one embodiment, the general seller 515, like the manager seller 513, may sell the product within the registered sales products of the master seller 511. According to one embodiment, the general seller 515 may generate an online shop including at least one of the registered products of the master seller 511.

Accordingly, the general seller 515, as the bottom seller in the hierarchy, may perform the main role of selling the products.

According to one embodiment, the hierarchy of the sellers 510 may include a plurality of sellers for each stratum. For example, the hierarchy of the sellers 510 may include a plurality of master sellers 511, a plurality of manager sellers 513 subordinate to each of the plurality of master sellers 511, and a plurality of general sellers 515 subordinate to each of the plurality of manager sellers 513.

According to one embodiment, when registering the content creator or purchaser 520 as the seller in the hierarchy at the request of at least one of the plurality of sellers 510 in the hierarchy, the platform server (e.g., platform server 100 of FIG. 1) may register the content creator or purchaser 520 as the sub-seller subordinate to the upper seller who requested the registration.

According to one embodiment, the platform server may register the content creator or purchaser 520 as the sub-seller of an existing master seller 511-1 at the request of the master seller 511-1. For example, when the request is made by the existing master seller 511-1, the platform server may basically register the content creator or purchaser 520 as a manager seller 513-5 directly subordinate to the existing master seller 511-1. For example, the content creator or purchaser 520 newly registered as the seller may be in the same position as that of the existing manager sellers 513-1 and 513-3. For another example, even when the request is made by the existing master seller 511-1 as described above, the platform server can selectively register the content creator or purchaser 520 as a general seller 515-7 who is indirectly subordinate to the master seller 511-1 through the existing manager seller 513-1. For example, the content creator or purchaser 520 newly registered as the seller may be in the same position as that of the existing general sellers 515-1, 515-3, and 515-5.

According to one embodiment, the platform server may register the content creator or purchaser 520 as the sub-seller indirectly subordinate thereto through another sub-seller based on usage history information of the platform service. For example, when it is more appropriate for the content creator or purchaser 520 to be registered as the general seller 515-7 indirectly subordinated thereto through the existing manager seller 513-1 rather than the manager seller 513-5 directly subordinate to the master seller 511-1, according to the usage history information of the platform service, the platform server may register the content creator or purchaser 520 as the general seller 515-7. According to one embodiment, a case in which it is more appropriate for the content creator or purchaser 520 to be registered as the indirectly subordinate sub-seller may be a case in which the content creator or purchaser 520 is more suitable for the main role assigned to each stratum of the hierarchy in light of the usage history information of the platform service. For example, the more suitable case in the matters described above may be a case where the content creator or purchaser 520 has no experience in being used as the manager seller.

According to one embodiment, the platform server may register the content creator or purchaser 520 as the sub-seller of the manager seller 513-1 at the request of the existing manager seller 513-1. For example, when the request is made by the existing manager seller 513-1, the platform server may register the content creator or purchaser 520 as the general seller 515-7 who is directly subordinate to the existing manager seller 513-1.

According to one embodiment, when registering the content creator or purchaser 520 as the seller at the request of the existing seller 510, approval from the upper seller may not be required. However, approval from the manager may be required separately.

According to one embodiment, when registering the content creator or purchaser 520 as the seller in the hierarchy based on the usage history information of the platform service, the platform server may register the purchaser 520 as a sub-seller subordinate to an appropriate upper seller. For example, when it is appropriate for the content creator or purchaser 520 to be subordinate to the master seller 511-1, the platform server may register the content creator or purchaser 520 as the manager seller 513-5. For another example, when it is appropriate for the content creator or purchaser 520 to be subordinate to the manager seller 513-1, the platform server may register the content creator or purchaser 520 as the general seller 515-7.

According to one embodiment, when the content creator or purchaser 520 is registered based on the usage history information, approval from the manager or the upper seller required for registration may be required.

According to one embodiment, the request from the existing seller 510 for registering the purchaser or content creator 520 as the seller may be made through the consulting information of the platform server. In addition, a process of registering the purchaser or content creator 520 as the seller based on the usage history information of the purchaser or content creator 520 may also be made through consulting information about the purchaser or content creator 520 of the platform server.

According to one embodiment, the platform server may register the operator 530 of the offline shop (e.g., offline shop 410 in FIG. 4) as the seller 510 in the hierarchy. For example, the platform server may register the operator 530 of the offline shop as a new master seller 511-3 in the hierarchy. When the operator 530 of the offline shop is registered as the new master seller 511-3, the operator 530 may be in the same position as that of the existing master seller 511-1. According to one embodiment, a sub-seller subordinate to the operator 530 of the offline shop registered as the master seller 511-3 may be registered. For example, a visitor to the offline shop may access the platform server through link information (e.g., QR code) and be registered as a sub-seller of the operator 530.

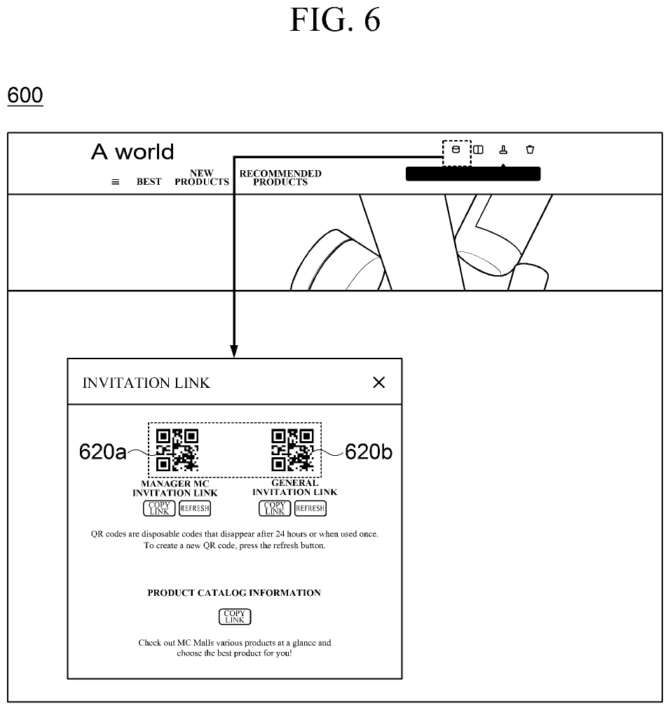

FIG. 6 is a diagram illustrating a UI of the existing seller for inviting a new seller in the e-commerce platform service according to an embodiment.

Referring to FIG. 6, the platform server (e.g., platform server 100 of FIG. 1) may provide invitation information according to the request of the seller in the hierarchy through a user invitation GUI 600.

According to one embodiment, the platform server may receive a user input 610 requesting the invitation information through the user invitation GUI 600. According to one embodiment, the platform server may provide invitation information 620 through the user invitation GUI 600. For example, the platform server may provide link information (e.g., QR code) 620a for registering as the seller of a designated stratum (e.g., manager seller). In addition, the platform server may provide link information 620b (e.g., QR code) for registering as a member of the online shop of the seller. For example, the link information may be invitation information for registering any user as the seller.

According to one embodiment, the seller may provide the provided invitation information to another user. According to one embodiment, the other user may be registered as a seller through invitation information provided by the seller. For example, the other user may use his or her terminal to recognize the link information (e.g., QR code) presented by the seller, access the platform server, and be registered as a seller.

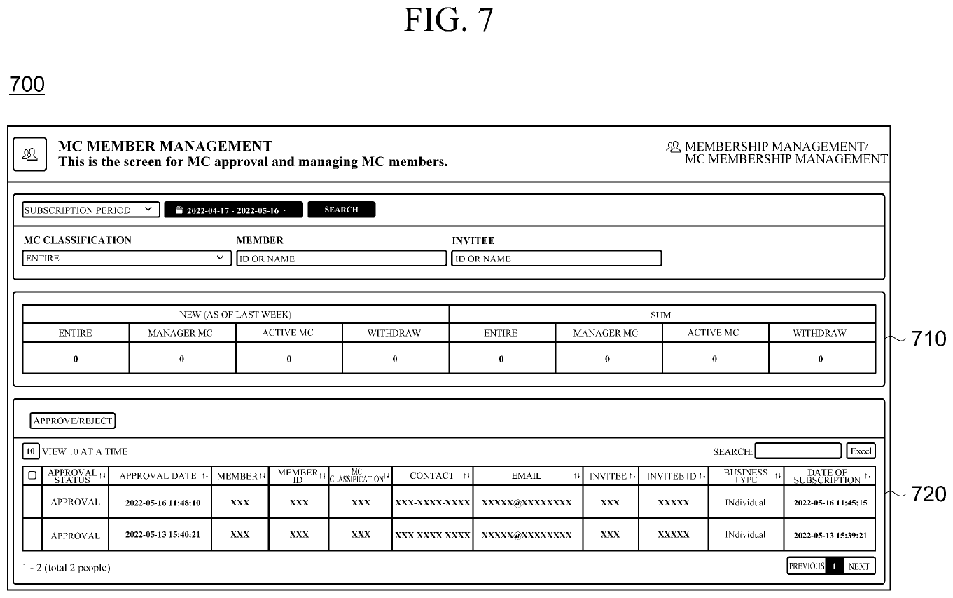

FIG. 7 is a diagram illustrating an UI of the existing seller for registering a new seller in the e-commerce platform service according to an embodiment.

Referring to FIG. 7, the platform server (e.g., platform server 100 of FIG. 1) may manage the user newly registered as the seller through a seller management GUI 700.

According to one embodiment, the platform server may provide state information 710 of the sub-seller. For example, the platform server may provide information about the number of sub-sellers for each stratum. In addition, the platform server may separately provide information about new sub-sellers when providing the number of sub-sellers.

According to one embodiment, the platform server may provide information 720 on the sub-seller requested to be registered as a seller. For example, the platform server may provide information on a user for being newly registered as a new seller through invitation information requested by the seller. According to one embodiment, when a procedure for registering the sub-seller is completed, the platform server may register the user of the platform service as the new seller in the platform service.

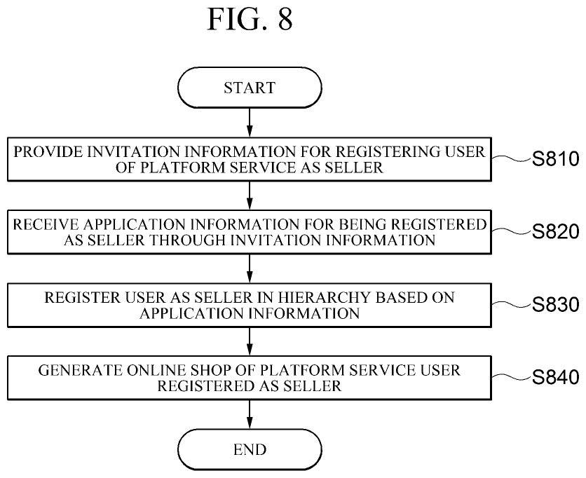

FIG. 8 is a diagram illustrating a method for providing the e-commerce platform service according to an embodiment.

Referring to FIG. 8, the platform server (e.g., the platform server 100 of FIG. 1) may provide the e-commerce platform service that registers the user of the platform service as a new seller.

According to one embodiment, in operation S810, the platform server may provide invitation information for registering the user of the platform service as a seller. For example, the platform server may provide the invitation information in response to a request of the existing seller. For another example, the platform server may provide the invitation information based on history information on use of the platform service of the user. The usage history information may include, for example, at least one of creation content information on content provided to the platform service and purchase history information. According to one embodiment, in operation S820, the platform server may receive application information for being registered as the seller through the invitation information. For example, the platform server may provide a page for receiving application information for the user to be registered as the seller through the terminal of the user who accessed the platform server through the invitation information, and receive the information required for the user to be registered as the seller.

According to one embodiment, in operation S830, the platform server may register the user of the platform service as the seller in the hierarchy based on the received application information. For example, when the invitation information is provided in response to the request of the existing seller, the platform server may register the user in the platform service as a sub-seller of the seller who requested the invitation information. For another example, when the platform server provides the invitation information based on the usage history information of the user, the platform server may register the user as a sub-seller subordinate to one of the existing sellers based on the usage history information.

According to one embodiment, in operation S840, the platform server may generate the online shop of the user of the platform service registered as the seller. For example, the online shop may include at least one of sales products registered by the upper seller of the hierarchy. The sales products may be at least one of the supply products registered on the platform.

According to one embodiment, the operations S810 to S820 may be implemented by a computer program stored in a computer-readable storage medium and configured to be executed by one or more processors. The computer program may include an instruction set implementing the operations S810 to S840 in a programming language.

The e-commerce platform service provided through the platform server 100 according to various embodiments described in FIGS. 1 to 8 allows the supplier, the seller, and the content creator for distributing and selling products to come together in one platform service, and thus they can easily find experts outside their own field and cooperate with each other to sell the products. In addition, the e-commerce platform service can reduce the risks that users who cooperate in selling the products should bear when they sell the products on their own, allow the users to focus on their respective fields of expertise and do their best, and further promote product sales by distributing sales profits according to a proportion of contribution to products sales of the users, thereby increasing each person's profits and creating a virtuous cycle structure in which each person develops in his/her field. In addition, this virtuous cycle structure of the e-commerce platform service can prevent damage to the suppliers and the sellers due to competition for the lowest price in the existing open market, and form a healthy market that provides purchasers with high-quality products at reasonable prices.

According to embodiments disclosed herein, the e-commerce platform service provided through the platform server allows the supplier, the seller, and the content creator for distributing and selling products to come together in one platform service, and thus they can easily find experts outside their own field and cooperate with each other to sell the products. In addition, the e-commerce platform service can reduce the risks that users who cooperate in selling the products should bear when they sell the products on their own, allow the users to focus on their respective fields of expertise and do their best, and further promote product sales by distributing sales profits according to a proportion of contribution to products sales of the users, thereby increasing each person's profits and creating a virtuous cycle structure in which each person develops in his/her field. In addition, this virtuous cycle structure of the e-commerce platform service can prevent damage to the suppliers and the sellers due to competition for the lowest price in the existing open market, and form a healthy market that provides purchasers with high-quality products at reasonable prices.

In addition, the e-commerce platform service of the platform server expands the scope of the e-commerce platform service by allowing users having a good understanding of the e-commerce platform service and sales products to be registered as new sellers in the hierarchy consisting of a plurality of sellers, thereby capable of increasing the flexibility and diversity of the service and minimizing the decrease in market reliability due to the addition of the new sellers.

What is claimed is:

1. An e-commerce platform server comprising:
a communication device;
a memory configured to store one or more instructions; and
a processor configured to execute the one or more instructions stored in the memory, wherein the processor is configured, by executing the one or more instructions, to:
register supply products of a supplier to be sold in an e-commerce platform service in a supply products database (DB);
register a plurality of sellers in a seller DB in a hierarchy consisting of an upper seller and at least one sub-seller subordinate to the upper seller, sales products and sales conditions of the sub-seller being subordinate to the upper seller to whom the sub-seller is subordinate, and whether or not to register the sub-seller and a sales state being managed by the upper seller;
register sales products of a top seller of the hierarchy in the sales products DB, the sales products being at least one of the supply products registered in the supply products DB;
generates an online shop of each of the plurality of sellers including at least one of the registered sales products of the top seller;
register content of a content creator for promoting sales products in the generated online shop in a content DB, the registered content being provided to a user of the e-commerce platform service;
sell a product to a purchaser through the generated online shop;
register at least one of the content creator and the purchaser, who are the users of the e-commerce platform service, as a seller in the hierarchy in the seller DB, based on usage history information in a process of selling the product; and
generate an online shop of the user registered as the seller, the online shop including at least one of the sales products of the top seller to whom the user registered as the seller is subordinate.

2. The e-commerce platform server of claim 1, wherein the processor is further configured, by executing the one or more instructions, to:
provide invitation information for registering the user as a seller;
receive application information for being registered as the seller from a terminal of the user through the invitation information; and
register the user as the seller in the hierarchy in the seller DB based on the received application information, when registering the user as the seller in the hierarchy.

3. The e-commerce platform server of claim 2, wherein the processor is further configured to, by executing the one or more instructions, provide the invitation information in response to a request from at least one terminal among a plurality of sellers included in the hierarchy, when providing the invitation information.

4. The e-commerce platform server of claim 3, wherein the processor is further configured, by executing the one or more instructions, to:
transmit the invitation information to a terminal of a designated user as the seller if a request for registering the designated user is received from a terminal of the seller, when providing the invitation information in response to the request; and
receive application information from the terminal of the designated user through the invitation information, when receiving the application information.

5. The e-commerce platform server of claim 4, wherein the processor is further configured, by executing the one or more instructions, to:
provide consulting information for recommending the designated user to at least one terminal among the plurality of sellers based on usage history information of the e-commerce platform service; and
receive a request for invitation information for registering the designated user as the seller from the terminal of the seller who provided the consulting information.

6. The e-commerce platform server of claim 1, wherein the usage history information includes at least one of creation history information of content for promoting sales products on the e-commerce platform service and purchase history information.

7. The e-commerce platform server of claim 3, wherein the processor is further configured, by executing the one or more instructions, to:
transmit the invitation information to the terminal of the seller that requested the invitation information in response to a request for registering any user as the seller from the seller terminal, when providing the invitation information; and
receive the application information from the terminal of the user who received the invitation information from the seller, when receiving the application information.

8. The e-commerce platform server of claim 3, wherein the processor is further configured to, by executing the one or more instructions, register the user to be registered through the invitation information in the seller DB as a sub-seller subordinate to the seller who requested the invitation information.

9. The e-commerce platform server of claim 3, wherein the processor is further configured to, by executing the one or more instructions, register, based on the usage history information on the e-commerce platform service of the user, the user as a sub-seller directly subordinate to the seller who requested the invitation information, or as a sub-seller indirectly subordinate to the seller who requested the invitation information through another sub-seller who is subordinate to the seller who requested the invitation information, when registering the user as the sub-seller of the seller who requested the invitation information.

10. The e-commerce platform server of claim 2, wherein the processor is further configured, by executing the one or more instructions, to:
determine a user to be registered as a sub-seller subordinate to a designated top seller in the hierarchy based on the usage history information and transmits the invitation information to a terminal of the determined user, when providing the invitation information;
receive the application information from the terminal of the determined user through the invitation information when receiving the application information; and
register the user as the sub-seller subordinate to the designated top seller when registering the user as the seller in the hierarchy.

11. The e-commerce platform server of claim 10, wherein the processor is further configured to, by executing the one or more instructions, provide consulting information including information on the designated top seller and the invitation information based on the usage history information.

12. The e-commerce platform server of claim 1, wherein the processor is further configured to, by executing the one or more instructions, register an operator of an offline shop, who is a user of an online platform service, as the seller in the hierarchy in the seller DB, when registering the user as the seller in the hierarchy.

13. The e-commerce platform server of claim 12, wherein the processor is further configured, by executing the one or more instructions, to:
register the operator of the offline shop as a top seller of the hierarchy in the seller DB, when registering the operator of the offline shop as the seller; and
register a product sold in the offline shop in the sales products DB and generate the online shop of the operator including the product of the offline shop registered as the sales products, when creating an online shop of the user registered as the seller.

14. The e-commerce platform server of claim 12, wherein the processor is further configured to, by executing the one or more instructions, generate a catalog containing the products registered in the sales products DB, and the generated catalog includes link information that leads to each product page where sales products in the online shop of the operator is purchased.

15. The e-commerce platform server of claim 12, wherein the processor is further configured to, by executing the one or more instructions, register a visitor of the offline shop as a member of the online shop of the operator when the visitor accesses the e-commerce platform server through invitation information of the operator.

16. The e-commerce platform server of claim 12, wherein the processor is further configured to, by executing the one or more instructions, provide recommendation information about at least one of a plurality of online shops on the e-commerce platform based on purchase history information at the offline shop when a visitor of the offline shop accesses the e-commerce platform server through the invitation information of the operator.

17. The e-commerce platform server of claim 12, wherein the processor is further configured to, by executing the one or more instructions, register a visitor of the offline shop in the seller DB as a sub-seller subordinate to the operator registered as the seller when the visitor accesses the e-commerce platform server through the invitation information of the operator.

18. A method for operating a server that provides an e-commerce platform service, the method comprising:
registering supply products to be sold of a supplier in the e-commerce platform service in a supply products database (DB);
registering a plurality of sellers in a seller DB in a hierarchy consisting of an upper seller and at least one sub-seller subordinate to the upper seller, sales products and sales conditions of the sub-seller being subordinate to the upper seller to whom the sub-seller is subordinate, and whether or not to register the sub-seller and a sales state being managed by the upper seller;
registering sales products of a top seller of the hierarchy in the sales products DB, the sales products being at least one of the supply products registered in the supply products DB;
generating an online shop of each of the plurality of sellers including at least one of the registered sales products of the top seller;
registering content of a content creator for promoting sales products in the generated online shop in a content DB, the registered content being provided to a user of the e-commerce platform service;
selling a product to a purchaser through the generated online shop;
registering at least one of the content creator and the purchaser, who are the users of the e-commerce platform service, as a seller in the hierarchy in the seller DB, based on usage history information in a process of selling the product; and
generating an online shop of the user registered as the seller, the online shop including at least one of the sales products of the top seller to whom the user registered as the seller is subordinate.

19. A computer program stored in a computer-readable storage medium and configured to be executed by one or more processors in order to execute an operation method of a server providing an e-commerce platform service, the computer program including:
an instruction for registering supply products to be sold of a supplier in the e-commerce platform service in a supply products database (DB);
an instruction for registering a plurality of sellers in a seller DB in a hierarchy consisting of an upper seller and at least one sub-seller subordinate to the upper seller, sales products and sales conditions of the sub-seller being subordinate to the upper seller to whom the sub-seller is subordinate, and whether or not to register the sub-seller and a sales state being managed by the upper seller;
an instruction for registering sales products of a top seller of the hierarchy in the sales products DB, the sales products being at least one of the supply products registered in the supply products DB;
an instruction for generating an online shop of each of the plurality of sellers including at least one of the registered sales products of the top seller;
an instruction for registering content of a content creator for promoting sales products in the generated online shop in a content DB, the registered content being provided to a user of the e-commerce platform service;
an instruction for selling a product to a purchaser through the generated online shop;
an instruction for registering at least one of the content creator and the purchaser, who are the users of the e-commerce platform service, as a seller in the hierarchy in the seller DB, based on usage history information in a process of selling the product; and
an instruction for generating an online shop of the user registered as the seller, the online shop including at least one of the sales products of the top seller to whom the user registered as the seller is subordinate.
